(19) United States
(12) Patent Application Publication
(10) Pub. No.: US 2006/0029702 A1
(43) Pub. Date: Feb. 9, 2006

(54) Continuous aqueous process for the isolation of hemicellulose from corn hulls and other plant hulls

(75) Inventors: Roger E. McPherson, Muscatine, IA (US); John L. Scott, Muscatine, IA (US); Jeff Underwood, Muscatine, IA (US)

Correspondence Address: BANNER & WITCOFF, LTD., TEN SOUTH WACKER DRIVE, SUITE 3000, CHICAGO, IL, 60606, US

(73) Assignee: Grain Processing Corporation, Muscatine, IA (US)

(21) Appl. No.: 11/196,504

(22) Filed: Aug. 4, 2005

Related U.S. Application Data
(60) Provisional application No. 60/599,625, filed on Aug. 6, 2004.

(51) Int. Cl. A23L 1/216

(52) U.S. Cl. 426/481; 426/523

(57) ABSTRACT

Various methods of obtaining hemicellulose from plant sources are provided. In one embodiment, hemicellulose is obtained from plant hulls by first jet cooking a plant hull slurry to remove starch from the plant hulls, and subsequently jet cooking the destarched plant hull slurry to extract a solubilzed hemicellulose. In an alternative embodiment, hemicellulose may be obtained by forming a plant hull slurry, adding sufficient lime to enable starch gelatinization and separation of hemicellulose in a single jet cooking step, jet cooking the slurry, and separating solubilized hemicellulose from insolubles. Surprisingly, the yield of hemicellulose is high, and the starch from the plant hulls will gelatinize but will not become hydrolyzed, such that the formation of reducing sugars is substantially avoided.

This application claims priority to provisional application Ser. No. 60/599,625 filed Aug. 6, 2004, which is hereby incorporated by reference in its entirety.

### FIELD OF THE INVENTION

The invention is directed to the field of processes for isolating hemicellulose from plant hulls.

### BACKGROUND OF THE INVENTION

Various methods have been developed in the prior art to isolate hemicellulose from plant hulls, such as corn hulls. Hemicellulose is a polymer that has commercial potential for a variety of applications, including industrial, food, pharmaceutical, and personal care products.

Typically, when obtaining hemicellulose from corn hulls, starch is removed from the hulls, and hemicellulose is isolated from the destarched hulls. One method to remove starch is to treat the corn hulls with alpha amylase in a batch reaction with typical reaction conditions of 800 to 95° C. and pH of 6 to 7 for 1 to 4 hours, depending on the enzyme concentration. The resultant starch hydrolyzate, which contains a substantial quantity of sugars, is removed by dewatering and washing the enzyme-treated corn hulls. Such alpha-amylase destarching is purportedly exemplified in Buchanan, et al. International Pat. Publ. No. WO 00/47701, and is taught in Antrim et al., U.S. Pat. No. 4,038,481).

Destarching with alpha amylase has the potential to produce a hemicellulose product with undesirable color. The reducing sugars are labile in alkaline conditions and can themselves degrade into colored by-products. In addition, the reducing sugars can react with the amino groups of proteins, peptides and amino acids in the corn hull to form new chemical molecules that possess undesirable color, as well as undesirable flavor and aroma. If washing of the enzyme treated hulls is incomplete, such side reactions may occur downstream in the overall process.

In the conventional processes, after the destarching of the hulls, hemicellulose is extracted from the destarched corn hulls. Frequently, the pH of the destarched corn hull slurry is adjusted to a pH above 10 with sodium hydroxide and/or calcium hydroxide. The alkaline slurry is heated to temperatures as high as 100° C. for an hour or more in a batch reaction. The hemicellulose is debound from the cellulose in the hulls, thus yielding an aqueous slurry of insoluble materials that includes dissolved hemicellulose in the aqueous phase. This technique is purportedly exemplified in a number of references, including Watson and Williams, U.S. Pat. No. 2,868,778, Buchanan, et al., Intl. Pat. Publ. No. WO 00/47701, Takeuchi, et al., U.S. Pat. No. 5,622,738, and Antonucci, U.S. Pat. No. 4,927,649, and is taught in Antrim and Harris, U.S. Pat. No. 4,038,481.

The invention seeks to provide a method for obtaining hemicellulose from plant hulls.

### BRIEF SUMMARY OF THE INVENTION

Various methods for obtaining hemicellulose from plant hulls are provided.

It has now been found that jet cooking is a suitable method for the destarching of plant hulls and the extracting of hemicellulose. In accordance with one embodiment of the invention, a method for obtaining hemicellulose comprises continuously jet cooking a ground plant hull slurry to destarch the plant hulls. The destarched plant hull slurry is then jet cooked to extract hemicellulose, generally under alkaline conditions, preferably in the presence of calcium. Preferably, solubilized hemicellulose is then separated from insolubles by a method such as centrifugation. Most preferably, after separation, the hemicellulose is refined by bleaching, filtration, diafiltration, or other suitable methods. The hemicellulose may be concentrated and spray-dried to yield a hemicellulose powder of high purity.

In accordance with another embodiment, the invention provides a method in which the plant hulls are mixed with water to form a plant hull slurry, and the pH is adjusted to an alkaline pH, preferably in the presence of calcium and most preferably with lime (calcium hydroxide). Subsequently, the slurry is jet cooked. After jet cooking, solubilized hemicellulose is continuously separated from insolubles (such as starch and cellulose). Such separation can be accomplished by any suitable method, such as centrifugation at a temperature at which the starch is insoluble. Again, the hemicellulose may be refined, concentrated, and spray dried.

In other embodiments, the invention is directed towards a hemicellulose powder prepared in accordance with the inventive methods taught herein. The hemicellulose can be made to have a higher purity than hemicellulose made in accordance with conventional industrial methods.

These and other features of the invention are discussed in more detail hereinbelow.

### BRIEF DESCRIPTION OF THE DRAWINGS

FIG. 1 illustrates a flow chart of an embodiment of the present invention that results in a hemicellulose product with cellulose-enriched by-product.

FIG. 2 illustrates a flow chart of another embodiment of the present invention that results in a hemicellulose product.

FIG. 3 is a chart illustrating the effect of calcium hydroxide dosage on the starch impurity content in the hemicellulose product prepared in accordance with Example 6.

FIG. 4 is a chart illustrating the effect of calcium hydroxide dosage on final hemicellulose product turbidity prepared in accordance with Example 6.

FIG. 5 is a chart illustrating the effect of calcium hydroxide dosage on the color of the hemicellulose product prepared in accordance with Example 6.

FIG. 6 is a chart illustrating the effect of calcium hydroxide dosage on the molecular weight of the hemicellulose product prepared in accordance with Example 6.

FIG. 7 is a chart illustrating the effect of calcium hydroxide dosage on the starch content of the Unders Centrifuge Cake prepared in accordance with Example 6.

### DETAILED DESCRIPTION OF THE PREFERRED EMBODIMENTS

The preferred plant hulls for use in the methods of the present invention are corn hulls. Much of the remaining discussion focuses on hemicellulose obtained from corn hulls, but it should be understood that hemicellulose obtained from other sources are within the scope of the present invention.

The domestic U.S. hybrid corn crop is enormous and stable, and the composition of the corn seeds does not vary significantly. Corn crops provide a reliable, low cost, and consistent source of hulls, bran, and spent germ as byproducts from the production of starch, corn flour, protein and oil. Corn hulls from the corn wet milling industry are a good, inexpensive, source for hemicellulose.

Corn hulls may comprise hemicellulose, cellulose, starch, protein, fat, acetic acid, ferulic acid, diferulic acid, coumaric acid, and trace amounts of other materials such as phytosytosterols and minerals. For example, an accepted composition of commercially produced corn hulls or corn bran is as follows:

| | |
|---|---|
| Hemicellulose | 56.38% |
| Cellulose | 18.79% |
| Starch | 8.14% |
| Protein | 7.90% |
| Fat | 1.69% |
| Acetic acid | 3.51% |
| Ferulic acid | 2.67% |
| Diferulic acid | 0.58% |
| Coumaric acid | 0.33% |
| Other | (trace) |

Cellulose is a glucan polymer of D-glucanopyranose units linked together via β-(1-4)-glucosidic bonds. The average DP (degree of polymerization) for plant cellulose ranges from a low of about 50 to about 600. Cellulose molecules are randomly oriented and have a tendency to form inter- and intra-molecular hydrogen bonds. Most isolated plant cellulose is highly crystalline and may contain as much as 80% crystalline regions. The hemicellulose fraction of plants is composed of a collection of polysaccharide polymers with a typical lower DP than the cellulose in the plant. Hemicellulose contains mostly D-xylopyranose, D-glucopyranose, D-galactopyranose, L-arabinofuranose, D-mannopyranose, and D-glucopyranosyluronic acid, with minor amounts of other sugars. The various forms of hemicellulose and the ratio of hemicellulose to cellulose is not well defined and may vary from plant to plant or from crop to crop within a given plant.

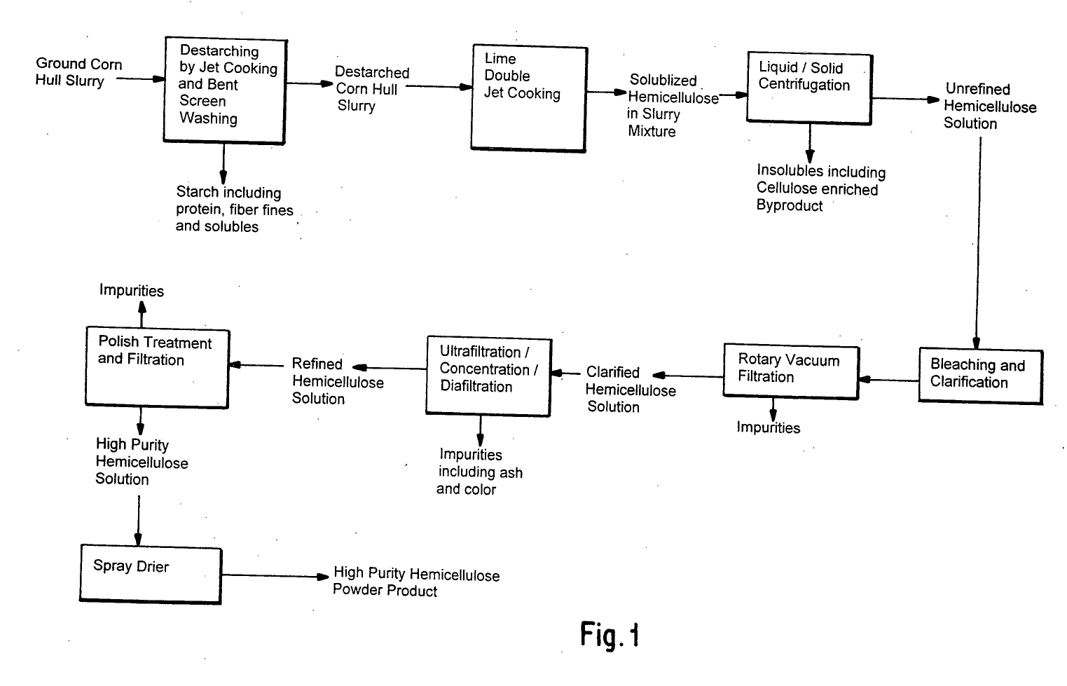

In accordance with one embodiment of the invention, as diagramatically illustrated in FIG. 1, hemicellulose is prepared by jet cooking and screening for destarching corn hulls, followed by high-temperature (>300F), high pressure (>4 atmospheres), jet cooking with lime to selectively solubilize hemicellulose from other corn hull components, with subsequent diafiltration to provide a low ash hemicellulose product. In other embodiments, an alternative alkaline material is used, but preferably calcium is present and most preferably lime is used. In this embodiment, the hulls are destarched and resolved into hemicellulose and insoluble components in separate jet cooking steps. Because the starch is removed from the corn hulls early in the process (thus providing a cleaner cellulose feedstock after centrifugation) this method is preferred if cellulose is to be recovered as a co-product.

The ground corn hull slurry can be formed using any suitable technique. For example, dried US Number 2 grade hybrid yellow dent corn hulls from a corn wet milling process may be ground to a particle size suitable for jet cooking. The ground corn hulls then may be mixed with water to form a slurry.

To destarch the hulls, the ground corn hull slurry is subjected to continuous jet cooking above 212° F. and 1 atmosphere and at neutral pH for several minutes, followed by screening and washing the cooked corn hulls at approximately 180° F. An example of a suitable jet cooker is a Hydroheater Jet Cooker. Jet cooking of corn hulls results in a product that allows separation of starch from the corn hulls by screening. For example, jet cooking of corn hulls at temperatures above 212° F. and 1 atmosphere and at a relatively neutral pH will result in a gelatinized starch product. Preferred jet cooking conditions are a temperature of above about 220 F, more preferably about 229 F to about 300 F, a pressure of approximately 20 psig, a pH range of 6.5 to 7.0, and a reaction time of less than 5 minutes.

Surprisingly, upon jet cooking the starch under such conditions, a substantial amount of the starch originally present in the hulls may be removed by washing with water at approximately 180° F. across a screen having an effective size to separate liquids and solids (in this instance, a DSM bent screen). The starch is soluble at these temperatures, thus allowing separation of the starch from the insoluble hulls. It is believed that the thermal energy and moisture imparted by the steam within the jet cooker will gelatinized the starch without substantially hydrolyzing the starch. The dextrose equivalent (D.E.) of the carbohydrate will remain unchanged at essentially zero, and accordingly, almost no reducing sugars will be produced. Moreover, the carbohydrate is substantially removed by the washing step. The risk of formation of color, flavor and aroma in subsequent processing steps is thus minimized. The first jet cooking also is believed to begin to debind the hemicellulose and other components of the hulls.

In the extracting step, lime is added to the slurry, and the limed, destarched corn hull slurry is subjected to continuous jet cooking at a temperature above 270° F. and a pressure of 4 atmospheres for several minutes and flashed to atmospheric pressure. In other embodiments, a different alkaline material may be added, although calcium is preferably present. Preferably, plural jet cooking steps are employed; for instance, the slurry then may be jet cooked at a temperature above 270° F. and a pressure of 4 atmospheres for several minutes. The first pass yield of hemicellulose is high, typically around 81% (this being expressed as percentage of theoretical original hemicellulose), and the yield after the second jet cooking step is also high, typically around 82%. This double jet cooking extraction may be carried out in less than 20 minutes. Typically, the hulls are jet cooked at a temperature of 315° to 330° F., a pressure of approximately 100 psig, and a calcium hydroxide dosage of greater than 15% corn hulls on a dry solids basis, although any suitable conditions may be employed.

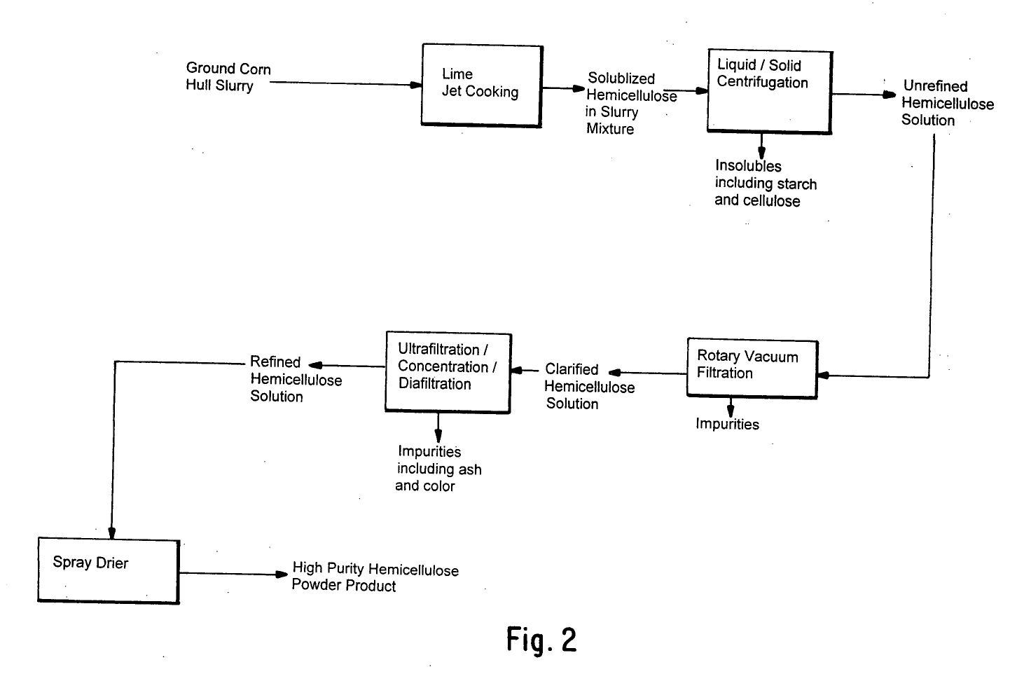

In the alternative embodiment illustrated in FIG. 2, a ground corn hull slurry is mixed with lime (calcium hydroxide) in a dosage of greater than 15% dry solids basis corn hulls, preferably at least 20% and more preferably around 25%. The slurry is jet cooked in a single step above 315° F. and 6 psig for several minutes. In this process, destarching of the corn hulls and extraction of hemicellulose from the hulls surprisingly occurs in a single step, and the final hemicellulose product typically exhibits low turbidity, low color, low starch content, and a slightly lower molecular weight than in the first embodiment heretofore described. The jet cooking may be followed by separation of solubilized hemicellulose from insolubles (such as starch and cellulose) and more preferably, by additional refining steps. To separate starches, the starch preferably is cooled to a temperature at which the starch is not soluble. The of the aqueous solution can be adjusted to below about 6 and then centrifuged to remove insolubles.

If desired, the recovered hemicellulose may be bleached, such as by treating with hydrogen peroxide at pH 8.7 and 160° F. initially in a batch reactor for 90 minutes. Alternatively, hydrogen peroxide or another suitable bleaching agent (such as sodium hypochlorite, potassium permanganate or hydrogen peroxide) may be continuously feed into the stream going to a continuously stirred tank reactor with a residence time of 90 minutes. Bleaching is believed to improve color, flavor and aroma.

If desired, the hemicellulose thus obtained can be partially depolymerized. Partially depolymerized hemicellulose has a lower viscosity than hemicellulose, as evaluated in an aqueous solution at the same solids content and temperature. The partially depolymerized hemicellulose can be obtained by any suitable method. The term “partially depolymerized,” as used herein refers generally to the product obtained when hemicellulose is subjected to a depolymerization reaction under conditions such that a partially depolymerized hemicellulose is obtained. Partial depolymerization of cellulose and hemicellulose are known in the art and can be accomplished, for example, enzymatically or chemically. Enzymatic partial depolymerization is purportedly taught in U.S. Pat. Nos. 5,200,215 and 5,362,502. Chemical partial depolymerization is purportedly taught in R. L. Whistler and W. M. Curbelt, J. Am. Chem. Soc., 77, 6328 (1955). The product of partial depolymerization of the hemicellulose has not been characterized with certainty, but it is presently believed that partial depolymerization by enzymatic methods occurs via random enzymatic cleavage.

Preferably, the partial depolymerization reaction is carried out enzymatically, i.e., under enzymatic catalysis. In a preferred embodiment, the hemicellulose is partially depolymerized with a xylanase enzyme, such as a xylanase that is active under acidic pH. In such case, the pH of the hemicellulose-rich soluble phase of the alkaline hydrolyzate typically is undesirably high and should be adjusted to a pH at which the depolymerizing enzyme is active. When a xylanase that is active under acidic conditions is used, the xylanase is preferably one which is active in the hemicellulose-containing soluble phase below about pH 7, and is most preferably active in the hemicellulose-containing soluble phase at about pH 4.8. In a particularly preferred embodiment, the enzyme utilized in the enzymatic partial depolymerization reaction is GC-140 xylanase, which is available from Genencor International, Rochester, N.Y.

Enzymatic partial depolymerization of hemicellulose may be regulated by controlling the reaction conditions that affect the progress of the depolymerization reaction, for example, the enzyme dosage, temperature, and reaction time. Monitoring of the depolymerization reaction can be accomplished by any suitable method known in the art. For example, the rate or extent of depolymerization can be measured on the basis of viscosity, which typically decreases as the average molecular weight of hemicellulose product decreases during the partial depolymerization reaction. The viscosity (or the rate of change of viscosity over time) can be measured with a viscometer, for example, the rapid viscometer marketed by Foss Food Tech. Corp., Eden Prairie, Minn. When a rapid viscometer is used to measure viscosity, it is preferably measured at 25° C. after the solution is allowed to equilibrate thermally for about 15 minutes.

Any enzyme dosage (weight of enzyme relative to the overall weight of solution) as may be found to be suitable for depolymerizing the hemicellulose may be used in connection with the invention. For example, in one embodiment xylanase enzyme is used at a dosage ranging from about 0.1 g to about 0.3 g of xylanase per about 5000 g of hemicellulose solution obtained from a plant source. It will be appreciated that the rate and/or the extent of depolymerization achieved at one enzyme dosage can be increased by using a relatively higher enzyme dosage. In this regard, the reaction time required to achieve partial depolymerization is inversely proportional to the enzyme dosage. It will also be appreciated that the enzymatic partial depolymerization reaction can exhibit a “plateau,” during the course of the enzymatic partial depolymerization reaction at which the average molecular weight of the partially depolymerized hemicellulose (as evaluated, for example, by viscosity measurements) does not substantially continue to decrease as the reaction continues. Typically, the plateau is preceded by a relatively rapid initial rate of partial depolymerization. It has been found, for example, that the partial depolymerization of a soluble phase hemicellulose solution having an initial viscosity of 290 cp (measured with a rapid viscometer) exhibited a plateau at a viscosity of about 199 cp when the enzyme dosage was 0.1288 g enzyme per 5000 g of hemicellulose solution (9.4% solids). However, when an enzyme dosage of 0.2542 g enzyme per 5000 g of solution was employed under similar conditions the reaction exhibited a plateau at a solution viscosity of about 153 cp. It will thus be appreciated that a particular enzymatic reaction may reach a plateau at a different average molecular weight depending on the enzyme dosage or on the particular enzyme used. Preferably, the enzymatic partial depolymerization is allowed to proceed until the plateau is reached.

The reaction may proceed at any suitable temperature. For example, when GC-140 xylanase (commercially available from Genencor International, Rochester, N.Y.) is used, the temperature is most preferably about 59° C., and the reaction time is most preferably about 4 hours when the xylanase dosage ranges from about 0.1 g to about 0.3 g of xylanase per about 5000 g of reaction solution. The enzymatic reaction can be terminated by any suitable method known in the art for inactivating an enzyme, for example, by adjusting the pH to a level at which the enzyme is rendered substantially inactive; by raising or lowering the temperature, as may be appropriate, or both. For example, xylanases that are active at acidic pH's can be inactivated by raising the pH to about 7.2 and simultaneously raising the temperature to about 90° C.

The depolymerization of the hemicellulose may proceed to any suitable extent. In many cases, it will be desired that the partially depolymerized hemicellulose will still have a film-forming property. In such cases, the hemicellulose may depolymerized to an average molecular weight between 50,000 and 100,000 Daltons, although the hemicellulose may be depolymerized to any other desired level.

The following examples are provided to illustrate the invention, but should not be construed as limiting the invention in scope.

### EXAMPLE 1

### Isolation of Hemicellulose Using Plural Jet Cooking Steps

Dry corn hulls were ground to a smaller particle size suitable for jet cooking. Four hundred pounds of corn hulls were added to 420 gallons of water in an agitated tank to form a slurry, and the pH of the slurry was adjusted to 6.95. The slurry passed through a jet cooker with a discharge temperature of 246° F. and 44 psig.

The gelatinized starch was removed from the cooked hull slurry by screen separation on a DSM bent screen. Gelatinized starch, protein including some fiber fines and solubles passed through the screen. These destarched cooked hulls were harvested from the top of the screen and washed two more times in this fashion.

The washed corn hulls were mixed with water to form a slurry, and calcium hydroxide added was added in an amount of 15 % of the destarched corn hulls on a dry solids basis. The pH was measured and was found to be 11.0. The slurry was jet cooked at 307° F. and 101 psig and flashed to atmospheric pressure. The resultant product was pumped through a second jet at 332° F. and 90 psig.

The extracted, solubilized hemicellulose was separated from the remaining material by centrifugation with a Sharples P-660 centrifuge. The centrifuge unders was a cake that contained cellulose and other insolubles. The centrifuge overs comprised an aqueous hemicellulose solution. The pH of this solution was adjusted to be in the range of 10.5 to 8.83 with hydrochloric acid. The solution was bleached using hydrogen peroxide in a batch reaction tank held for 90 minutes at 163° F.

The bleached hemicellulose solution was clarified by adding magnesium silicate, (“Haze-Out” from The Dallas Group), for ten minutes at pH 7.0 and 125° F. The mixture was rotary vacuum filtered with a precoat of Celite-577 filter aid. The filtrate product was tested for the presence of oxidant. If positive, sodium bisulfite was added until the solution tested oxidant negative.

The solution was then filtered through a Niagara filter with Celite 503 filter aid precoat on glass filter pads. The filtrate was then passed through a 5 micron filter and then was introduced to an ultrafiltration unit with a 10,000 molecular weight cut-off membrane. The UF feed was kept at 120-130° F. The retentate was concentrated and then diafiltered to a conductivity of 700 microSiemens.

The ultrafiltered retentate was spray dried. The product was a high-purity hemicellulose powder. The properties of this hemicellulose powder product are shown in Table I in Example 3.

### EXAMPLE 2

### Isolation of Bleached Hemicellulose Using Plural Jet Cooking Steps

Dry corn hulls were ground to a particle size suitable for jet cooking. The ground corn hulls, 346 pounds as is basis, were placed into 480 gallons of water to form a slurry in an agitated tank (approximately 8% dry solids slurry). The pH was adjusted to a pH of 6.85 using NaOH 50%. The slurry was pumped through a jet cooker with a discharge temperature of 232° F. and 67 psig.

The starch was removed from the cooked hull slurry by separation on a DSM bent screen. The gelatinized starch and other materials including protein, fiber fines and solubles passed through the screen. The separated cooked hulls remaining on top of the screen were harvested, and this washing step was repeated twice more.

The washed, destarched hulls were mixed with water to form a slurry. Calcium hydroxide was added in an amount of 15.3% of the destarched corn hulls on a dry solids basis. The pH of the slurry was measured to be 11.6. The slurry was jet cooked at 322° F. and 108 psig. The resultant cooked slurry product was cooked again in a second jet cooker at 335° F. and 93 psig.

The solubilized, extractable hemicellulose was separated from the remaining insoluble material by centrifugation with a Sharples P-660 centrifuge. The unders or cake included cellulose and other insolubles. The hemicellulose solution overs were pumped to a continuous stirred tank reactor where 35% hydrogen peroxide bleach was continuously added at a flow rate of 30 ml per minute. The residence time in the reactor was 90 minutes and the temperature was 86° F.

The non-refined, bleached hemicellulose solution had a dry solids content of approximately 5.5%. This solution was pumped into rotary vacuum filter feed tank where magnesium silicate was added and the pH subsequently adjusted to 4.0 with hydrochloric acid. The rotary vacuum filter contained a CO-1 heel (medium particle size diatomaceous earth) and a Celite-577 (fine particle size diatomaceous earth) topcoat applied over the heel. The filtrate had a dry solids content of approximately 4.2%. This solution was polish filtered with a 0.5 micron CUNO filter.

The purified hemicellulose solution was concentrated up to 12.5% dry solids in an evaporator and then spray dried to produce a hemicellulose powder product. The properties of this hemicellulose powder product are shown in Table I in Example 3.

### EXAMPLE 3

### Isolation of Bleached Hemicellulose Using Plural Jet Cooking Steps

Dry corn hulls were ground to smaller-sized particles suitable for jet cooking. The ground corn hulls, 346 pounds as is basis, were placed into 480 gallons of water to form a slurry in an agitated tank (approximately 8% dry solids). The slurry pH was adjusted to 6.67 using NaOH (50%). The slurry was passed through a jet cooker with a discharge temperature of 229° F. and 50 psig.

The starch was removed from the cooked hull slurry by separation on a DSM bent screen. The gelatinized starch and other materials including protein, fiber fines and solubles passed through the screen. The separated cooked hulls remaining on top of the screen were harvested and mixed with water in 180° F. agitated tank and passed over the DSM screen for a second time. This step was repeated a third time.

The washed, destarched hulls were mixed with water to form a slurry. Calcium hydroxide was added in an amount of 17.2% of destarched corn hulls on a dry solids basis. The pH was measure to be 11.7. The slurry was jet cooked at 274° F. and 63 psig. The resultant cooked slurry product was cooked again in a second jet at 326° F. and 100 psig.

The solubilized, extractable hemicellulose was separated from the remaining insoluble material by centrifugation with a Sharples P-660 centrifuge. The unders were a cellulose-enriched by-product having a solids content of approximately 16.9%. The hemicellulose solution overs were pumped into a continuously stirred tank reactor (CSTR) where hydrogen peroxide bleach was continuously added. The residence time in the CSTR at 180-190° F. was 90 minutes.

The bleached hemicellulose solution continued to a rotary vacuum filtration feed tank where the pH was adjusted to 7.0 with hydrochloric acid. The solution was also titrated with sodium bisulfate until the present of oxidant tested negative. In addition, magnesium silicate was added to the feed. The precoat for the RVF was Celite-503. The RVF filtrate was maintained at 120-130° F. and filtered through a 0.5 micron Omni filter prior to ultrafiltration, concentration and diafiltration on a Niro Ultra-Filter with a 10,000 molecular weight cut-off. The ultrafiltration concentrate (which had a solids content of 3.7%) was diafiltered until the conductivity was below 1500 microSiemens.

The diafiltered, retentate product was treated with ‘Haze-Out’ to remove any remaining haze created by concentration in the ultrafiltration step. The mixture was polished through a Niagara filter with a Celite-503 precoat on polypropylene filter pads with a 1-3 micron porosity.

The filtered solution was spray dried to produce a purified, low ash hemicellulose powdered product. The properties of this hemicellulose powder product are shown in Table I.

TABLE I
Hemicellulose Product Characteristics

| | Ex. #1 | Ex. #2 | Ex. #3 |
|---|---|---|---|
| Purity (estimate) | | | |
| Hemicellulose, % dsb | 95 | 65.7 | 97.7 |
| Protein, % dsb | 1.9 | 4.8 | 2.1 |
| Starch, % dsb | 1.5 | 1.9 | 2.8 |
| Ash, % dsb | 1.3 | 21.2 | 4.0 |
| Total, % dsb | 99.7 | 93.6 | 106.6 |
| Physical Properties | | | |
| Molecular Weight, Mw (k) | 179.9 | 140.7 | 167.0 |
| Dry Solids | 93.6 | 91.4 | 89.3 |
| Moisture, % | 6.4 | 8.6 | 10.7 |
| Color of Solution | 1.07 | 5.36 | 2.5 |
| (absorbance at 450 nm of 0.5% | | | |
| solution) | | | |
| Turbidity (Solution at 0.5%), | 4 | 165 | Not |
| NTU | | | determined |
| Solubility, % | 94.6 | 98.2 | 94.7 |
| pH of Solution | 7.08 | 5.50 | 8.65 |
| Monosaccharide Composition | | | |
| Xylose, % of hemicellulose | 57.1 | 57 | 55.9 |
| Arabinose, % of hemicellulose | 35.4 | 35.2 | 35.3 |
| Galactose, % of hemicellulose | 7.5 | 7.9 | 8.8 |
| Total % | 100 | 100.1 | 100.0 |
| Cations in Ash | | | |
| Calcium, ppm dsb | 6,968 | 88,018 | 7,820 |
| Sodium, ppm dsb | 203 | 3,795 | 963 |
| Organic Molecule Content | | | |
| Glycerin, ppm dsb | 2.2 | 4,592 | 4.5 |
| Glucuronic Acid, ppm dsb | 2.9 | 30 | Not |
| | | | determined |
| Ferulic Acid, ppm dsb | 7.8 | Not | Not |
| | | determined | determined |

### EXAMPLE 4

### Destarching of Wheat Bran

Dry soft wheat bran was ground to a particle size suitable for jet cooking. The bran contained 10.3% moisture, 15.8% dry solid basis protein, 31.8% dry solids basis starch and 1.7% dry basis fat.

Eighty pounds of as-is ground soft wheat bran was added to 120 gallons of water in a well-agitated tank at ambient temperature of 70° F. to form a slurry. The pH was adjusted to 6.64 with 50% dry solids solution of sodium hydroxide.

The resulting slurry was continuously fed to a jet cooker equipped with a Hydroheater Combining Tube which generated high shear into the slurry at the point of contact with high pressure steam at approximately 150 psig. The cooking conditions were 219° F. discharge temperature, 20 psig and a residence time of 4.5 minutes.

The cooked soft wheat bran slurry was fed across a DSM Screen at high pressure. The DSM-filtered cooked soft wheat bran was then added to a well-agitated tank of water at 180° F. The slurry was filtered for a second time across a DSM Screen at high pressure. This washing process was repeated again.

The screened, cooked soft wheat bran was fed to a Mercone C-250 Centrifugal Screener and the excess water was removed. The harvested soft wheat bran was dried in a steam-jacketed ribbon blender and then ground in a Fitzpatrick Comminuting Mill and an Alpine Kolloplex Impact Stud Mill.

The final dry ground destarched soft wheat bran contained 8.7% moisture, 14.5% dry basis protein, 1.0% dry basis starch and 1.6% dry basis fat.

Soft Wheat Destarching Results

| Sample | % dsb Starch |
|---|---|
| Soft wheat bran | 31.8 |
| Destarched soft wheat bran | 1.0 |

The starch content on a dry solids basis was reduced by over 97%.

### EXAMPLE 5

### Destarching of Corn Hulls

Dried corn hulls from a corn wet milling process of US Number 2 grade yellow dent corn were ground to particle size suitable for jet cooking. The corn hulls contained 7.3% moisture, 6.9% dry basis starch, 8.10% dry basis protein and 1.88% dry basis fat. One hundred pounds, as-is basis, hulls were placed into 120 gallons water to form a slurry in a well-agitated tank at ambient temperature. The pH was adjusted to 6.6 with 50% sodium hydroxide.

The resulting slurry was continuously fed to a jet-cooker equipped with a Hydroheater Combining Tube which generated high shear into the slurry at the point of contact with high pressure steam at approximately 150 psig. The cooking conditions were 220° F. discharge temperature, 20 psig and a residence time of 4.5 minutes.

The cooked corn hull slurry was fed across a DSM Screen at high pressure. The DSM-filtered cooked corn hulls were than added to a well-agitated tank of water at 180° F. The resultant slurry was filtered for a second time across as DSM Screen at high pressure. This washing was repeated again.

The washed, cooked corn hulls were fed to a Mercone C-250 Centrifugal Screener and the excess water was removed. The dewatered corn hulls were dried in a steam-jacketed ribbon blender and ground in a Fitzpatrick Comminuting Mill and an Alpine Kolloplex Impact Stud Mill. The final dry ground destarched corn hulls contained 2.7% moisture, 0.9% dry basis starch, 5.0% dry basis protein, and 2.3% dry basis fat.

Corn Hull Destarching Results

| Sample | % dsb Starch |
|---|---|
| Corn hulls | 6.9 |
| Destarched corn hulls | 0.9 |

The starch content on a dry solids basis was reduced by 87%.

### EXAMPLE 6

### Extraction of Hemicellulose

Hemicellulose is obtained from the destarched wheat bran of Example 4 and the destarched corn bran of Example 5.

### EXAMPLE 7

### Isolation of Corn Hulls Using A Single Jet Cooking Step

Ground corn hulls were ground with an Alpine Kolloplex Impact Stud Mill to a particle size suitable for jet cooking. The moisture content of the corn hulls was 8.74%. A slurry was prepared by adding 414.7 grams as-is ground corn hulls to water to a total weight of 7570 g. To the well-agitated slurry, calcium hydroxide was added on a 20% dry basis of corn hulls, and the measured pH value was 11.53.

The resultant slurry was pumped through a jet cooker at 315° F. and 70 psig with a 15.9 minute residence time. The lime jet-cooked corn hulls were stored in a walk-in cold room over night. The cold product was warmed to 45° C. and centrifuged on a LWA Centrifuge. The starch was insoluble at this temperature. Most of the starch that was originally present in the corn hulls was removed in the centrifugation step. The centrifuge unders contained 14.99% dry solids basis starch.

The overs, which contained the solubilized hemicellulose, were collected and kept at 45° C. The pH was adjusted from 11.40 to 5.48 with glacial acetic acid. The pH adjusted centrifuge overs were vacuum filtered across a Whatman #1 precoated with CO-1 filter aid. A clear filtrate was collected.

The clear hemicellulose solution was further purified by ultrafiltration with a poly-sulfone membrane with a 100,000 molecular weight cut off. The retentate was diafiltered with reverse osmosis water at a temperature of 60° C.

The retentate was dried in a 500° C. oven over night. The starch content of the hemicellulose product was 1.4% dry solids basis.

This method was repeated using the same original ground corn hulls with varying dosages of calcium hydroxide added for the lime jet cooking step. The calcium hydroxide doses included 10%, 15% and 25% dry solids basis corn hulls. A slight variation in the measured pH value of the slurry was observed, and the jet cooking residence time was altered as shown below:

| Lime | Measured | Jet |
|---|---|---|
| Dosage | pH value | residence |
| % dsb | of the slurry | time, m |
| 10 | 11.49 | 14.5 |
| 15 | 11.60 | 16.4 |
| 20 | 11.53 | 15.9 |
| 25 | 11.82 | 15.9 |

The starch content in the final hemicellulose product is shown below.

| Calcium | Starch | Starch |
|---|---|---|
| Hydroxide | in hemicellulose | in centrifuge |
| Dosage | product | cake |
| % dsb | % dsb | % dsb |
| 10 | 15.73 | 5.85 |
| 15 | 9.84 | 10.82 |
| 20 | 1.40 | 14.99 |
| 25 | 1.39 | 14.08 |

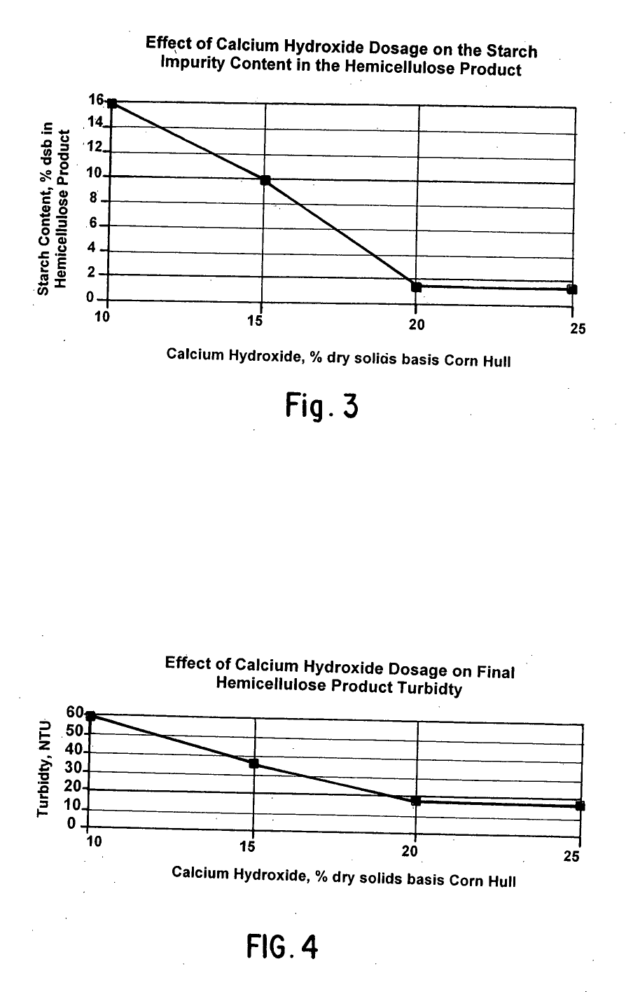

For a calcium dosage of 20% and higher dry solids basis corn hulls, the starch impurity content of the hemicellulose produce leveled out at 1.4% dsb. At the lower dosage levels of 10% and 15%, the amount of starch impurity in the final product was significantly higher. This is further illustrated in FIG. 3.

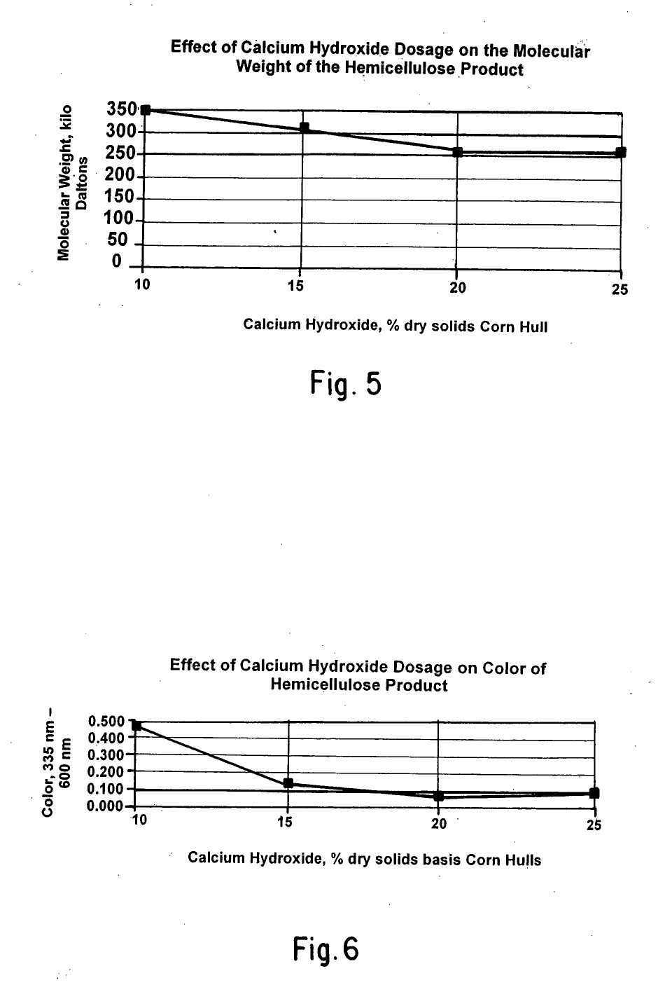

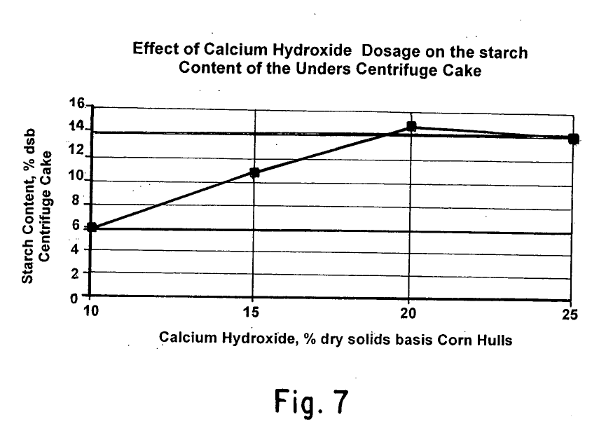

Also, it was discovered that the calcium hydroxide dosage had an effect on the turbidity, color and molecular weight of the final hemicellulose product. These properties are identified in the table below, and this data is graphically illustrated in FIGS. 4, 5, 6 and 7.

### Diafiltered Hemicellulose Product

| Calcium | | | | | | |
|---|---|---|---|---|---|---|
| Hy- | | | | | | |
| droxide | | | Color | | | |
| Dosage | | Turbidity | (absorbance | | | |
| % dsb | | (solution | at 450 nm | | | |
| Corn | Starch | at 0.5%) | of 0.5% | Protein | Ash | MW |
| Hulls | % dsb | NTU | solution) | % dsb | % dsbk | Daltons |
| 10 | 15.73 | 59 | 0.456 | 3.49 | 1.3 | 343.4 |
| 15 | 9.84 | 36 | 0.138 | 5.75 | 1.45 | 310.6 |
| 20 | 1.4 | 18 | 0.073 | 4.92 | 1.45 | 258.7 |
| 25 | 1.39 | 17 | 0.099 | 3.28 | 1.06 | 261.1 |

### EXAMPLE 8

### Unbleached, Partially Hydrolyzed Hemicellulose

Dried No. 2 yellow dent corn hulls from a corn wet milling process were ground to a particle size suitable for jet cooking. The corn hulls contained 6.8% moisture, 7.43% dsb protein and 11.0% dsb starch. The ground corn hulls, 66.2 pounds dry basis, were placed in 215 gallons of tap water in a well agitated tank to form a slurry. Calcium hydroxide was added in an amount of 15.8 pounds (25.4% dry solids basis corn hulls). The measured pH value of the slurry was 11.4.

The resultant slurry was continuously cooked in a jet cooker equipped with a Pick style steam injector, which generated high shear into the slurry at the point of contact with high-pressure steam at approximately 150 psig. The jet cooking conditions were 315-325° F. with an operating pressure of approximately 70 psig and 13 minutes of residence time.

The cooked corn hulls were fed sequentially to a BRPX-309SFV-39-60 Alpha Laval centrifuge and a KG 10006 Westfalia centrifuge. The unders or insolubles, which included starch and cellulose, were separated from the overs or solubilized hemicellulose containing liquid.

The centrifuge overs were filtered through a 0.5 micron CUNO filter. The pH of the filtrate containing hemicellulose and other soluble products was adjusted to a pH of 4.9 with acetic acid and the temperature was adjusted to 134° F.

Xylanase, (Genencor product, GC-140), 4.2 pounds, was added to the solution in a batch reactor. The reaction was maintained at a temperature of 134-136° F. and a pH of 4.5-5.0 for twenty four hours. The solution was then adjusted to pH of 6.85 with calcium hydroxide and heated to 210° F. to 212° F. to denature the enzyme.

The solution was cooled to 90° F. to 100° F. and filtered across a 0.5 micron wound yarn filter. The filtrate was diafiltered with tap water on a Niro-Ultra Filtration Unit containing a G-50 membrane with a molecular weight cut-off of 8,000 Daltons. The retentate product of 7.3% and conductivity of 1,530 microSiemens was concentrated on a Blaw-Know, Pilot RFL Evaporator to obtain a syrup product having a dry solids content of 18.5%. The properties of this product are set forth below:

| | |
|---|---|
| Molecular Weight | 82,600 (non-enzyme thinned, in range of |
| | 215,000 to 284,000) |
| Starch, % dsb | 0.01 |
| Protein, % dsb | 1.6 |
| Ash, % dsb | 1.71 |
| Calcium, ppm | 1,569 |
| Sodium, ppm | 77 |
| Turbidity, NTU | 68 |
| (1% soln) | |
| Color (absorbance at | 0.175 |
| 450 nm, 0.5% at | |
| pH of 4.0) | |

### EXAMPLE 9

### Hemicellulose

Dry corn hulls were ground to a smaller particle size suitable for jet cooking. Three hundred sixty pounds of corn hulls were added to 480 gallons of water in an agitated tank to form a slurry, and the pH of the slurry was adjusted to 6.75. The slurry passed through a jet cooker with a discharge temperature of 295° F. and 112 psig.

The gelatinized starch was removed from the cooked hull slurry by screen separation on a DSM bent screen. Gelatinized starch, protein including some fiber fines and solubles passed through the screen. The destarched cooked hulls were harvested from the top of the screen and washed two more times in this fashion (slurried with additional clean water).

The (3×) washed corn hulls were mixed with water to form a slurry and sodium hydroxide was added in an amount of 15% of the destarched corn hulls on a dry solids basis. The pH value was measured as 12.15. The slurry was jet cooked at 300° F. and 115 psig and flashed to atmospheric pressure. The resultant product was pumped through a second jet cooker at 335° F. and 110 psig.

35% Hydrogen peroxide was added to the 2^{nd} jet cooker product in a mixing tank at 150 mL/min and then held in a continuous stirred tank reactor at 180F with a preferred residence time of 4 hours. The extracted, bleached, and stabilized hemicellulose was separated from the remaining material by centrifugation with a Sharples P-660 centrifuge. The centrifuge unders was a cake that contained cellulose and other insolubles. The centrifuge overs comprised an aqueous hemicellulose solution.

The hemicellulose solution was cooled to 120° F. and hydrochloric acid was used to adjust the pH to 4.0. The hemicellulose solution was then checked for residual oxidants and BSS was added until the residual oxidants test was negative. Then magnesium silicate (“Haze-Out from the Dallas Group) was added and the solution was filtered using a rotary vacuum filter with a precoat of Celite 503.

The filtered solution was then added to 95% ethyl alcohol such that the alcohol percentage was 75% (150 proof). This step caused the hemicellulose to become a precipitate, which was recovered on a DSM bent screen with a 50-micron screen opening. The screen overs were captured and slurried in 95% ethyl alcohol such that the alcohol percentage was greater than 90% (180 proof). This hardened the hemicellulose and it was then recovered in a basket centrifuge.

The centrifuge cake was air-dried and ground on a pin mill until it passed through a US 60-mesh screen. Forced-air drying would have also been acceptable in a suitable commercial dryer.

The product obtained from this process is as follows:

| | |
|---|---|
| 88.0% | Hemicellulose (as-is) |
| 161,748 | Molecular Weight (Daltons) |
| 92.22% | Solids |
| 7.27% | Ash (as-is) |
| 1.259% | Protein (as-is) |
| 0.0% | Residual Oxidant (as-is) |

### EXAMPLE 10

The centrifuge unders cake from Example 9 was captured and slurried in enough water that the solids content was less than 2%. The temperature of the slurry was raised to 180° F. The pH of the slurry was adjusted to 7.0 with hydrochloric acid. BSS was added to the slurry until the test for residual oxidants was negative.

The slurry was then fed to a Sharples P-660 centrifuge and the unders cake was captured. The cake was added to water to form a slurry of less than 2% solids. Two more centrifuge wash cycles identical to this one were then followed.

The slurry after the 3^{rd} Sharples P-660 wash was pH adjusted to 4.8 and spray dried on a tower spray dryer. The pH was adjusted to achieve a desirable pH for functionality in a food.

It is thus seen that the invention provides methods for the production of hemicellulose.

While the invention has been described with respect to specific examples including presently preferred modes of carrying out the invention, those skilled in the art will appreciate that there are numerous variations and permutations of the above described systems and techniques.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention. No language in the specification should be construed as indicating that any non-claimed element is essential to the practice of the invention. Pressures referred to herein are gauge pressures.

Preferred embodiments of this invention are described herein, including the best mode known to the inventors for carrying out the invention. Variations of those preferred embodiments may become apparent to those of ordinary skill in the art upon reading the foregoing description. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim

1. A method for obtaining hemicellulose from plant hulls, comprising:
jet cooking the plant hulls under conditions of temperature and shear effective to at least substantially separate starch from the plant hulls to thereby form a jet cooked mixture wherein the starch is substantially soluble in the mixture;
substantially separating insoluble components of the jet cooked mixture from soluble components of the jet cooked mixture;
jet cooking the insoluble components under alkaline conditions and conditions of temperature and shear effective to release hemicellulose; and
recovering the hemicellulose.

2. The method of claim 1 wherein the plant hulls comprise corn hulls.

3. The method of claim 1 wherein the plant hulls are in the form of an aqueous slurry.

4. The method of claim 1 comprising jet cooking the plant hulls at a temperature of above 220 F and a pressure above 1 atm.

5. The method of claim 4 wherein the temperature at least about 229 F to about 300 F.

6. The method of claim 1 comprising jet cooking the hulls at a neutral pH.

7. The method of claim 1 wherein the alkaline conditions are obtained by a source of hydroxide.

8. The method of claim 7 wherein the alkaline conditions are obtained by addition of calcium hydroxide.

9. The method of claim 8 wherein the alkaline conditions are obtained by addition of sodium hydroxide.

10. The method of claim 1 further comprising jet cooking the insoluble components at a temperature above 270 F and a pressure above 4 atm.

11. The method of claim 10 wherein the temperature is about 315 F to about 330 F.

12. The method of claim 1 wherein the jet cooking of the insoluble components occurs in at least two jet cooking steps.

13. The method of claim 1 comprising recovering the hemicellulose by centrifugation.

14. The method of claim 1 further comprising refining the hemicellulose by bleaching, filtration, or diafiltration.

15. The method of claim 1 further comprising spray drying the hemicellulose to form a powder.

16. The method of claim 1 wherein the method is a continuous method.

17. A method for obtaining hemicellulose from plant hulls, comprising:
jet cooking the hulls under alkaline conditions under conditions of temperature and shear effective to separate starch and hemicellulose from other components of the hulls to thereby form a jet cooked mixture;
cooling the jet cooked mixture to a temperature at which the starch is insoluble; and
separating an aqueous solution of hemicellulose from the starch and other components of the hulls.

18. The method of claim 17 wherein the plant hulls comprise corn hulls.

19. The method of claim 17 wherein the plant hulls are in the form of an aqueous slurry.

20. The method of claim 17 comprising jet cooking the hulls at a temperature of at least about 315 F.

21. The method of claim 17 wherein the alkaline conditions are obtained by a source of hydroxide.

22. The method of claim 21 wherein the alkaline conditions are obtained by addition of calcium hydroxide.

23. The method of claim 22 wherein the calcium hydroxide is present in an amount of greater than 15% by weight dry solids basis.

24. The method of claim 23 wherein the calcium hydroxide is present in an amount of at least 20% by weight dry solids basis.

25. The method of claim 17 comprising separating the aqueous solution of hemicellulose from the starch and other components of the hulls by adjusting the pH of the aqueous solution to below about 6 and then centrifuging to remove insolubles.

26. The method of claim 17 further comprising refining the hemicellulose by bleaching, filtration, or diafiltration.

27. The method of claim 17 further comprising spray drying the hemicellulose to form a powder.

28. The method of claim 17 wherein the method is continuous.
